(19) United States
(12) Patent Application Publication
(10) Pub. No.: US 2024/0215574 A1
(43) Pub. Date: Jul. 4, 2024

(54) CONTROLLED-RELEASE DISPENSER ARTICLE FOR CONTROLLING INSECTS

(71) Applicant: ABERDEEN ROAD COMPANY, Emigsville, PA (US)

(72) Inventor: Angela M. COCO, York, PA (US)

(21) Appl. No.: 18/521,155

(22) Filed: Nov. 28, 2023

Related U.S. Application Data
(60) Provisional application No. 63/475,941, filed on Jan. 3, 2023.

(51) Int. Cl. A01N 25/34; A01N 25/08; A01N 25/18; A01N 31/02; A01N 35/06; A01P 19/00

(52) U.S. Cl. CPC A01N 25/34; A01N 25/08; A01N 25/18; A01N 31/02; A01N 35/06; A01P 19/00

(57) ABSTRACT

A controlled-release dispenser article for controlling insects. The article includes a dispenser body having a biodegradable carrier and an active ingredient. The biodegradable carrier is a material that, when combined with the active ingredient, provides controlled-release of the active ingredient into the environment. The active ingredient includes at least one component that manipulates insect behavior. A method for making the controlled-release dispenser article and a method manipulating insect behavior with the controlled-release dispenser are also disclosed.

### CROSS REFERENCE TO RELATED APPLICATIONS

This application is a non-provisional patent application claiming priority and benefit of U.S. Provisional Patent Application No. 63/475,941 filed Jan. 3, 2023, entitled “Hercon (Disrupt) (Attract) Bio-Beads”, currently pending, which is hereby incorporated by reference in its entirety.

### FIELD OF THE INVENTION

The present disclosure is generally directed to controlled-release dispenser articles for monitoring and/or controlling insect populations that are recognized as beneficials, pests, potential pests, and/or invasive species. In particular, the present disclosure is generally direct to solid, biodegradable dispenser articles, for example, in the form of a bead, pellet, or pastille, to provide controlled-release of insect or plant pheromone(s), other related chemicals, and/or insecticides.

### BACKGROUND OF THE INVENTION

Pheromones and related volatile chemicals are used by a variety of organisms, such as insects and plants, to provoke behaviors and communicate within their own species. Some organisms, such as insects, have also developed ways to detect and respond to chemicals produced by other organisms that are important to their survival. These chemicals are recreated in labs or collected naturally and released at a controlled rate to manipulate insect behavior. These recreated pheromones are utilized multiple ways by different industries, such as forestry, agriculture, and retail markets.

Dispensers that release pheromones at a controlled rate are used in Integrated Pest Management programs (IPM) to reduce total use of conventional pesticides. Pheromone and chemical dispensers (hereafter “pheromone dispensers”) may contain a single pheromone or a mixture of chemicals depending on the target insect species. Occasionally, they may also contain lethal insecticides. To monitor for or to control insect populations by catching them, pheromone dispensers (aka attractants and lures) are used with traps. To deter insect presence, pheromone dispensers (aka repellents) are used in a variety of ways. To disrupt insect behaviors, such as mating or gathering, pheromone dispensers (aka disruptants) are applied at defined rates per area. Disruptants and sometimes repellents differ from attractants and lures because they need to be applied at dense concentrations by hand or with the aid of machines. While attractants, lures, some repellents, and hand-applied disruptants are sometimes collected after they stop releasing pheromones or chemicals, disruptants applied using aircraft or vehicles are left in the environment and not recovered. The overwhelming majority of attractants, lures, repellants and disruptants available in the market are not biodegradable and remain in the environment indefinitely. Because of this, there is an increasing demand for affordable biodegradable pheromone dispensers in all categories: attractants, lures, repellents, disruptants, and insecticides. Currently available biodegradable products struggle with performance, user-friendliness, cost, and availability which make them unattractive to end-users.

What is needed is a method and article for controlling insects that are easy to use, are available at a low cost, have a reduced effect on the environment and utilize biodegradable materials that effectively manipulate insect behavior and does not suffer from the drawbacks of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

The controlled-release dispenser article according to the present disclosure includes an inert biodegradable carrier material or blend and an active ingredient comprising an active ingredient including a pheromone, related chemical, or insecticide. The controlled-release dispenser article according to this embodiment of the present disclosure is readily to inherently biodegradable. The controlled-release dispenser article according to the present disclosure may be a semi-solid to solid controlled-release pheromone dispenser article manufactured into a defined size and shape allowing for a controlled-release rate and efficacy of pheromone or related chemicals to adequately monitor or control target insects.

One embodiment of the present disclosure includes a controlled-release dispenser article for controlling insects. The article includes a dispenser body having a biodegradable carrier and an active ingredient. The biodegradable carrier is a material that, when combined with the active ingredient, provides controlled-release of the active ingredient into the environment. The active ingredient includes at least one component that manipulates insect behavior.

Another embodiment of the present disclosure includes a method for making a dispenser article. The method includes heating a biodegradable carrier to a sufficient temperature to permit miscibility of an active ingredient. An active ingredient is added to the heated biodegradable carrier. The biodegradable carrier and the active ingredient are mixed to form a mixture. The mixture is cooled to form a dispenser body. The active ingredient includes at least one component that manipulates insect behavior. The biodegradable carrier provides a controlled-release of the active ingredient into the environment.

Another embodiment of the present disclosure includes a method for manipulating insect behavior. The method includes providing a dispenser article having dispenser body. The dispenser body includes a biodegradable carrier and an active ingredient. The biodegradable carrier is a material that, when combined with the active ingredient, provides controlled-release of the active ingredient into the environment. The dispenser article is distributed include an environment containing insects. The insect behavior is manipulated with the active ingredient released by the dispenser article.

Other features and advantages of the present invention will be apparent from the following more detailed description of the preferred embodiment, taken in conjunction with the accompanying drawings which illustrate, by way of example, the principles of the invention.

### DETAILED DESCRIPTION OF THE INVENTION

The present disclosure includes an easy-to-use biodegradable dispenser article, which offers reliable controlled-release of pheromones and related chemicals to provide an environmentally conscious solution to issues relating to insect control.

The controlled-release dispenser article according to the present disclosure includes a biodegradable carrier material or blend and an active ingredient comprising a pheromone, related chemical or insecticide. By related chemical, as utilized herein, it is meant that the chemicals that may be utilize include those chemicals having a similar structure or isomers of the pheromones, such as -trans or -cis isomers of the pheromones. The dispenser article according to the present disclosure is readily or inherently biodegradable. Biodegradable, as utilized herein, is intended to mean any material or article capable of being decomposed by sunlight, water, bacteria or other living organisms. The dispenser article according to the present disclosure is in a semi-solid or solid form manufactured into a defined size and shape which allows for controlled-release rate and efficacy of pheromone or related chemicals to adequately monitor or control target insects. The shape and size of the dispenser article affects the total mass of active that an individual dispenser article is capable of containing. In one particularly suitable embodiment, the individual dispenser articles are of a uniform or substantially uniform shape and size to provide a release rate of active evenly across a specific area.

The biodegradable carrier is a material that, when combined with the active ingredient, provides controlled-release of the active ingredient into the environment. Environment, as utilized herein, is intended to mean the space, area, or location external to the biodegradable carrier, which may include insects and/or plants. The biodegradable carrier material can be selected from plant-based or synthetic material, such as waxes or other biodegradable carrier material. Suitable waxes for use in the biodegradable carrier material include, but are not limited to, non-polar class of organic compounds that are pliable solids near ambient temperatures. These materials typically melt into low viscosity liquids about 40° C. Suitable wax compounds may be selected from the family of waxes consisting of beeswax (filtered), lanolin, shellac wax, jojoba wax, palm wax, carnauba wax, candelilla wax, rice bran wax, soy wax, hydrocarbon-based waxes such as paraffin wax and other synthetic waxes, and other waxes such as microcrystalline, ozocerite, ceresin, and montan and any mix or related biodegradable compound thereof. The controlled-release of the active ingredient is provided by a chemistry related to interaction of the active ingredient with the biodegradable carrier material, with a mechanism similar to cold throw in candle scent technologies. To provide a suitable release rate and an increased mass of active ingredient, additives, such as microease additives may be provided to increase the maximum amount of active ingredient. For example, additives that increase the amount of active ingredient and provided the controlled-release may include, for example one or more of steric acid, VYBAR™ polymers, and synthetic wax (alkenes, C<10 α, polymerized—CAS #68527-08-2) to increase the mass % active ingredient the biodegradable carrier material can hold. For example, the additive may be added to provide a stable article that does not sweating the active ingredient out. These additives to support the controlled release may be natural or synthetic and may be less biodegradable than the biodegradable carrier material. Preferably, the additives are used in small amounts (e.g., less than 1wt %).

The active ingredient is a material that, when released into an environment manipulates the behavior of insects. The active ingredient is preferably selected to match the target insect or related arthropod to be managed. The active ingredient may be any suitable pheromone, related chemical, or insecticide that manipulates the behavior of insects. One particularly suitable active ingredient is 3-methyl-2-cyclohexen-1-one (MCH). For example, while not so limited, the MCH is a controlled-release pheromone formulation designed to lower incidence of attacks by certain bark beetle species in tree stands, including Douglas-fir beetle (Dendroctonus pseudotsugae). Controlled-release of MCH provides a reduction of the damage resulting from the Douglas-fir beetle. Another suitable active ingredient may include (8E,10E)-8,10-Dodecadien-1-ol. In this embodiment, the active ingredient may be released from the controlled-release dispenser to manipulate the behavior of codling moths or oriental fruit moth and other insects that are pests that attack orchards.

In addition, the controlled-release dispenser article may include other inert ingredients, including, but not limited to bitterants, dry or wet dye, anti-caking/sticking agents. Other additives may include FDA food grade and/or REACH-compliant color dye, plant powders, iron powder, and/or denatonium. The active ingredients may also include components selected from the group consisting of pheromones, related compounds and insecticides. In one embodiment, the controlled-release dispenser article is free of and does not contain emulsifiers.

The controlled-release dispenser articles includes a uniformly mixed solid or semi-solid, made of a wax compound or compounds, with or without additives (such as FDA food grade and/or REACH-compliant color dye, plant powders, iron powder, and/or denatonium), and an active ingredient or ingredients from one or more groups such as pheromones, semiochemicals and other plant compounds or one or more of their constituents, and biological, antimicrobial, and conventional pesticides. The dispenser articles may be coated with natural diatomaceous earth (CAS #61790-53-2) as an anti-sticking agent and/or an adhesive to help dispenser articles stick to a surface (such as a tree canopy). Where available, food grade ingredients are prioritized in the dispenser article ingredient mix. The formula is expected to be inherently biodegradable by microorganisms in the environment, especially in the soil, and bioaccumulation is unlikely due to the very low solubility of the materials.

By controlled-release, it is meant that the controlled-release dispenser releases the active ingredient into the environment over a period of time. In one embodiment, the biodegradable carrier and the active ingredient are combined to provide a controlled-release over a predetermined amount of time. For example, the controlled-release may release active ingredient into the environment for a time from about two weeks to about 5 months or from about 1 month to about 3 months about 2 months. The controlled-release rate may adjusted based on several factors, including, but not limited to, requirements of the environment, the insect life cycles (such as targeting adults that are mating), and the volatility of the active ingredient.

In one embodiment according to the present disclosure, the controlled-release dispenser article includes about 50 wt % to about 99 wt % waxes or from about 70 wt % to about 95 wt % or from about 75 wt % to about 92 wt % or from about 80 wt % to about 92 wt % or from about 82 wt % to about 90 wt % biodegradable carrier. In addition, in this embodiment, the controlled-release dispenser article includes from about 0.1 wt % to about 20 wt % or from about 1 wt % to about 17 wt % or from about 5 wt % to about 16 wt % or from about 10 wt % to about 15 wt % or from about 12 wt % to about 14 wt % active ingredient. In one embodiment, the controlled-release dispenser article contains less than about 15 wt % active ingredient or less than about 14 wt % active ingredient or less than about 12 wt % active ingredient. In addition, in this embodiment, the controlled-release dispenser article includes from about 0 wt % to about 15 wt % or from 0.1 wt % to about 10 wt % or from 0.2 wt % to about 5 wt % or from 0.5 wt % to about 2 wt % or from 0.75 wt % to about 1.25 wt % additives.

In one embodiment according to the present disclosure, from about 0 wt % to about 20 wt % or from about 1 wt % to about 15 wt % or from about 5 wt % to about 10 wt % or from about 7 wt % to about 9 wt % of the controlled-release dispenser article may include synthetic waxes. In one embodiment, about 50 wt % to about 99 wt % of the controlled-release dispenser article ingredients are food grade. In one embodiment, the controlled-release dispenser article is free of and does not contain synthetic wax. In addition, the controlled-release dispenser article may include a coating of from about 0 wt % to 4 wt % or from about 0.5 wt % to 2.0 wt % or from about 0.75 wt % to 1.25 wt % or from about 0.8 wt % to 1.0 wt % diatomaceous earth and/or an adhesive.

In another embodiment, the controlled-release dispenser article includes from about 10 wt % to about 15 wt % active ingredient, and from about 70 wt % to about 80 wt % biodegradable carrier. In still another embodiment, the biodegradable carrier includes a blend containing from about 5 wt % to about 10 wt % synthetic wax, from about 27 wt % to about 33 wt % soy wax, from about 14 wt % to 18 wt % carnauba wax, from about 24 wt % to about 28 wt % beeswax and from 4 wt % to about 8 wt % paraffin wax.

The inert ingredients, including the biodegradable carrier, are mixed and heated. For example, the heating of the biodegradable carrier is to a sufficient temperature to permit miscibility of an active ingredient. Once the mixture is the consistency and temperature suitable for incorporation of the active ingredient into the biodegradable carrier, the active ingredient is added and mixed. For example, the mixture is melted to a homogenous liquid where the mixture is fee flowing and not solids are visible. The mixture is extruded from an extruder or pastillator to a desired size and shape and then cooled. While not so limited, suitable sizes for the controlled-release dispenser article include a diameter from about 5 mm to about 7mm or from about 5.5 mm to about 6.8 mm or from about 5.8 mm to about 6.5 mm. Surface modifying ingredients, such as diatomaceous earth is added after the product is cooled. These additional anti-caking/sticking agents may be added to the cooled dispenser articles as needed to prevent caking or sticking. The dispenser body formed may include the form of, for example, a bead, pellet, or pastille. Other solid or semi-solid configurations may be formed by the method according to the present disclosure.

The controlled-release dispenser articles are placed in an environment where target insects are present. The placement of the controlled-release dispenser articles may be accomplished according to any known method including mechanical or manual distribution, such as by a mechanical spreader or other particle distribution device. The chemicals released from the controlled-release dispenser articles modify the insect's behavior or poisons the insect, depending on the active ingredient used. The insects are then repelled, trapped, or killed. The pheromone dispenser articles can be used in a variety of locations, such as but not limited to forests or fields. The invention is compatible with a variety of active ingredients, making it a versatile tool for insect management. The controlled-release is a delayed release of the active ingredient over a predetermined amount of time.

Dispenser articles according to the present disclosure may be dispersed along a surface with or without an adhesive (such as a tree canopy or the ground), placed in a trap (such as a bucket trap), placed in a biodegradable or synthetic satchel or pouch and hung, or applied another way. The active ingredient(s) gradually migrate through the dispenser article and evaporate into the environment at a controlled-release rate over time. The release rate is controlled by the different wax species and the ratio of each species relative to each other in the uniform mix. In particular, the amount of a synthetic wax (CAS #68527-08-2) in the mix is critical for controlled-release rate of the dispenser article.

### EXAMPLES

A formulation of a controlled-release dispenser article is shown in Table 1 and includes an active ingredient 3-methyl-2-cyclohexen-1-one (MCH), a mixture of synthetic was, carnauba wax, beeswax and paraffin wax as the biodegradable carrier, an optional bitterant additive, Bitrex and diatomaceous earth as an optional anti-caking/sticking agent.

TABLE 1

| | Ingredient | Percent Weight in |
|---|---|---|
| Ingredient | Purpose | formulation |
| MCH-CAS 1193-18-6 | Active Ingredient/ | 13.88% (<1% |
| | Pheromone | impurities) |
| Synthetic Wax-CAS | Inert carrier | 7.93% |
| # 68527-08-2* | | |
| Soy Wax** | Inert carrier | 29.73% |
| Carnauba wax** | Inert carrier | 15.86% |
| Filtered Beeswax, White | Inert carrier | 25.77% |
| (*/** depending on supplier) | | |
| Paraffin Wax** | Inert carrier | 5.95% |
| Bitrex ®** | bitterant | 0.01% |
| Natural Diatomaceous | Anti-caking/ | 0.89% |
| Earth** | sticking agent | |

*Denotes cosmetic grade
**Denotes food grade

While the exemplary embodiments illustrated in the figures and described herein are presently preferred, it should be understood that these embodiments are offered by way of example only. Accordingly, the present application is not limited to a particular embodiment but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes, and omissions may be made in the design, operating conditions and arrangement of the exemplary embodiments without departing from the scope of the present application.

1. A controlled-release dispenser article for controlling insects, the article comprising:
a dispenser body having a biodegradable carrier and an active ingredient, the biodegradable carrier being a material that, when combined with the active ingredient, provides controlled-release of the active ingredient into the environment;
wherein the active ingredient includes at least one component that manipulates insect behavior.

2. The controlled-release dispenser article according to claim 1, wherein the dispenser body is a solid or semi-solid.

3. The controlled-release dispenser article according to claim 1, wherein the dispenser body is in the form of a bead, pellet, or pastille.

4. The controlled-release dispenser article according to claim 1, comprising from about from about 0.1 wt % to about 20 wt % active ingredient, from about 50 wt % to about 99 wt % biodegradable carrier.

5. The controlled-release dispenser article according to claim 1, wherein the dispenser body contains less than about 15 wt % active ingredient.

6. The controlled-release dispenser article according to claim 1, wherein the biodegradable carrier is a synthetic or natural wax.

7. The controlled-release dispenser article according to claim 1, wherein the active ingredient includes one or both of a pheromone and insecticide.

8. The controlled-release dispenser article according to claim 1, wherein the active ingredient includes 3-methyl-2-cyclohexen-1-one.

9. The controlled-release dispenser article according to claim 1, wherein the active ingredient includes (8E,10E)-8,10-Dodecadien-1-ol.

10. The controlled-release dispenser article according to claim 1, wherein the biodegradable carrier includes from about 5 wt % to about 10 wt % synthetic wax, from about 27 wt % to about 33 wt % soy wax, from about 14 wt % to 18 wt % carnauba wax, from about 24 wt % to about 28 wt % beeswax and from 4 wt % to about 8 wt % paraffin wax.

11. The controlled-release dispenser article according to claim 1, wherein the active ingredient is 3-methyl-2-cyclohexen-1-one and is present in an amount of from about 13 wt % to 14 wt % and the biodegradable carrier includes from about 7.5 wt % to about 8.5 wt % synthetic wax, from about 29 wt % to about 31 wt % soy wax, from about 15.5 wt % to 16.5 wt % carnauba wax, from about 25 wt % to about 26.5 wt % beeswax and from 5 wt % to about 7 wt % paraffin wax.

12. The controlled-release dispenser article according to claim 1, further comprising a bitterant.

13. The controlled-release dispenser article according to claim 1, further comprising an anti-caking/sticking agent.

14. A method for making a dispenser article comprising:
heating a biodegradable carrier to a sufficient temperature to permit miscibility of an active ingredient;
adding the active ingredient to the heated biodegradable carrier;
mixing the biodegradable carrier and the active ingredient to form a mixture;
forming and cooling the mixture to form a dispenser body;
wherein the active ingredient including at least one component that manipulates insect behavior and the biodegradable carrier provides a controlled-release of the active ingredient into the environment.

15. The method according to claim 14, wherein the dispenser body formed is a solid or semi-solid.

16. The method to claim 14, wherein the dispenser body formed is in the form of a bead, pellet, or pastille.

17. The method according to claim 14, wherein the active ingredient includes one or both of a pheromone and insecticide.

18. The method according to claim 14, wherein the active ingredient includes 3-methyl-2-cyclohexen-1-one.

19. The method according to claim 14, wherein the active ingredient includes (8E,10E)-8,10-Dodecadien-1-ol.

20. The method according to claim 14, wherein the active ingredient is 3-methyl-2-cyclohexen-1-one and is present in an amount of from about 13 wt % to 14 wt % and the biodegradable carrier includes from about 7.5 wt % to about 8.5 wt % synthetic wax, from about 29 wt % to about 31 wt % soy wax, from about 15.5 wt % to 16.5 wt % carnauba wax, from about 25 wt % to about 26.5 wt % beeswax and from 5 wt % to about 7 wt % paraffin wax.

21. A method for manipulating insect behavior, the method comprising:
providing a dispenser article having dispenser body, the dispenser body comprising:
a biodegradable carrier and an active ingredient, the biodegradable carrier being a material that, when combined with the active ingredient, provides controlled-release of the active ingredient into the environment;
distributing the dispenser article into an environment containing insects;
manipulating insect behavior with the active ingredient released from the dispenser article.

22. The method according to claim 21, wherein the dispenser body is a solid or semi-solid.

23. The method to claim 21, wherein the dispenser body is in the form of a bead, pellet, or pastille.

24. The method according to claim 21, wherein the active ingredient includes one or both of a pheromone and insecticide.

25. The method according to claim 21, wherein the active ingredient includes 3-methyl-2-cyclohexen-1-one.

26. The method according to claim 21, wherein the active ingredient includes (8E,10E)-8,10-Dodecadien-1-ol.

27. The method according to claim 21, wherein the active ingredient is 3-methyl-2-cyclohexen-1-one and is present in an amount of from about 13 wt % to 14 wt % and the biodegradable carrier includes from about 7.5 wt % to about 8.5 wt % synthetic wax, from about 29 wt % to about 31 wt % soy wax, from about 15.5 wt % to 16.5 wt % carnauba wax, from about 25 wt % to about 26.5 wt % beeswax and from 5 wt % to about 7 wt % paraffin wax.
